(19) United States
(12) Patent Application Publication
(10) Pub. No.: US 2010/0273004 A1
(43) Pub. Date: Oct. 28, 2010

(54) MULTI-LAYER COATING FILM STRUCTURE

(75) Inventors: Takakazu YAMANE, Hiroshima (JP); Sakura NAKANO, Hiroshima (JP); Hiroshi KUBOTA, Hiroshima (JP)

Correspondence Address: Studebaker & Brackett PC, One Fountain Square, 11911 Freedom Drive, Suite 750, Reston, VA, 20190, US

(73) Assignee: MAZDA MOTOR CORPORATION, Hiroshima (JP)

(21) Appl. No.: 12/755,080

(22) Filed: Apr. 6, 2010

(30) Foreign Application Priority Data
Apr. 24, 2009 (JP) 2009-106351

(51) Int. Cl. B32B 27/38

(52) U.S. Cl. 428/413

(57) ABSTRACT

The average light transmissivity of a wavelength range of 300 through 390 nm of upper-layer coating films is less than 0.5% and the average light transmissivity of a wavelength range of 390 through 450 nm of those is 6.5% or less. Or, the average light transmissivity of the wavelength range of 300 through 390 nm of the upper-layer coating films is 0.5% or more and the average light transmissivity of the wavelength range of 390 through 450 nm of those is 4.5% or less. Accordingly, the deterioration resistance against lights can be improved without forming any second coating film in a multi-layer coating film structure comprising the upper-layer coating films formed on a lower-layer coating film formed by an electrocoating or the like.

### BACKGROUND OF THE INVENTION

The present invention relates to a multi-layer coating film structure which is formed on an outer panel of a vehicle body or the like.

In general, a multi-layer coating film structure which comprises a lower-layer coating film (undercoating film) formed with a rustproof electrocoating paint, a second coating film formed on the lower-layer coating film, and an upper-layer coating film (final coating film) formed on the second coating film, has been applied in painting of metal products, such as an outer panel of a vehicle body, which may require weatherproofness.

The above-descried second coating film is provided to improve the deterioration resistance against lights, chipping resistance, and color forming. Especially, in the lower-layer coating film which is formed with an epoxy-based cation electrocoating paint, the large-amount ultraviolet radiation causes deterioration of the surface of this coating film, so that an upper-layer coating film formed on this coating film may peel off. Therefore, the lower-layer coating film is protected against the ultraviolet rays by the second coating film to improve the deterioration resistance against lights.

Meanwhile, it has been tried from viewpoints of less resources, less processes, cost reduction, and so on that the upper-layer coating film is directly formed on the lower-layer coating film without any second coating film. European Patent Publication No. 0823289 A1, for example, discloses a multi-layer coating film structure, in which a first color base coating having sublayer-hiding function is applied on a cation electrocoating film, a second color base coating having transparency is applied on the film without substantially curing the film, and a clear coating is further applied after heating and thereby curing the both color base coating films. Herein, the first color base coating has the function of the second coating film, and the average light transmissivity (an average value of the light transmissivity of a wavelength range of 400 through 700 nm) of this formed coating film is set to be 0.1% or less to provide sublayer-hiding function.

Meanwhile, Japanese Patent Laid-Open Publication No. 2001-40245 discloses a photocatalystic hydrophilic coating composition including a light shield material which is related to the paint considering the improvement of the deterioration resistance against lights. This is to prevent the light of the wavelength range of 290 through 390 nm from reaching the boundary between a base member and the coating film by using the light shield material, and the above-described publication discloses that the average light transmissivity of the wavelength of 325 nm is set to be less than 10% and the average light transmissivity of the wavelength of 390 nm is set to be 50% or less.

### SUMMARY OF THE INVENTION

An object of the present invention is to provide a multi-layer coating film structure comprising a lower-layer coating film and an upper-layer coating film provided directly on the lower-layer coating film, which can improve the deterioration resistance against lights properly by the upper-layer coating film without any deterioration of the color forming, especially without forming any second coating film or its alternative.

As described above, it has been conventionally considered that the radiation of visible rays may not affect the deterioration against lights so much compared to the ultraviolet radiation, so the deterioration resistance against lights of the lower-layer coating film may be mainly reduced by the ultraviolet radiation. According to the experiments and researches conducted by the inventors of the present invention, however, the light transmissivity of the wavelength range of the visible rays was basically greater than that of the ultraviolet rays as shown in FIG. 1. Accordingly, it was found that in case the second coating film was not formed, a large amount of visible rays would reach the lower-layer coating film through the upper-layer coating film, so that the influence of the visible rays on the deterioration of the lower-layer coating film would not be negligible. Further, it was found that if the light transmissivity of the visible rays was set to be properly small (low), the light deterioration of the lower-layer coating film could be greatly suppressed without forming any second coating film or its alternative, keeping appropriate color forming or good appearance of the coating film.

According to the present invention, there is provided a multi-layer coating film structure, comprising a lower-layer coating film, and an upper-layer coating film provided directly on the lower-layer coating film, wherein the upper-layer coating film has the average light transmissivity of a wavelength range of 300 through 390 nm which is less than 0.5% and the average light transmissivity of a wavelength range of 390 through 450 nm which is 6.5% or less, or the average light transmissivity of the wavelength range of 300 through 390 nm which is 0.5% or more and the average light transmissivity of the wavelength range of 390 through 450 nm which is 4.5% or less.

Herein, “the average light transmissivity” means an average value of the light transmissivity which are measured for a specified wavelength range every one wavelength (1 nm), like 300 nm, 301 nm, 302 nm, . . . .

While there has been no established definition of the wavelength of the ultraviolet rays, the present invention will be described as the wavelength range of 300 through 390 nm (i.e., 300 nm or more and 390 nm or less) is considered as the ultraviolet (ultraviolet-rays) range (especially, the near ultraviolet range), and the wavelength range of 390 through 450 nm (i.e., 390 nm or more and 450 nm or less) is considered as the visible (visible-rays) range (especially, the low-wavelength-side visible range). Herein, while the wavelength range of 390 nm belongs to both ranges of the near ultraviolet range and the visible range according to the above-described explanation (definition), this explanation (definition) may not raise any critical issue in defining the present invention.

The above-described present invention of the upper-layer coating film having the average light transmissivity of the near ultraviolet range which is less than 0.5% and the average light transmissivity of the low-wavelength-side visible range which is 6.5% or less, or the average light transmissivity of the near ultraviolet range which is 0.5% or more and the average light transmissivity of the low-wavelength-side visible range which is 4.5% or less generally means that in case the average light transmissivity of the near ultraviolet range is greater (higher), the average light transmissivity of the low-wavelength-side visible range is set to be smaller (lower).

That is, since the light deterioration of the lower-layer coating film is caused not only by the ultraviolet rays but also by the visible rays, in order to suppress the light deterioration of the lower-layer coating film by the upper-layer coating film, it is necessary to set the light transmissivity of the upper-layer coating film to be small (low) not only for the ultraviolet range but also for the visible range. The light transmissivity of the ultraviolet range changes depending on the color of the coating film, and in case of the color of the coating film having the greater light transmissivity of the ultraviolet range, the light deterioration of the lower-layer coating film is suppressed, so it may be necessary to set the light transmissivity of the visible range to be properly small (low). Meanwhile, in case of the color of the coating film having the lower light transmissivity of the ultraviolet range, an upper limit of the light deterioration of the visible range can be set to be properly great (high).

Further, since the light deterioration of the ultraviolet range which is less than 300 nm is almost zero, so its influence on the light deterioration of the lower-layer coating film is negligible as shown in FIG. 1, it can be probably said that only the range of 300 through 390 nm (the near ultraviolet range) should be considered regarding the ultraviolet range.

With regard to the visible range, meanwhile, while the light transmissivity becomes greater as the wavelength becomes longer (greater) than 450 nm, such longer-wavelength rays does not substantially cause the light deterioration of the lower-layer coating film. On the contrary, if the light transmissivity of the visible range over the wavelength of 450 nm is set to be small, the color of the coating film becomes dark, so that the appearance of the coating film is inferior. That is, according to the above-described present invention, since setting the average light transmissivity of the visible range to be properly small is limited to the specified low-wavelength range of 390 through 450 nm, the light deterioration of the lower-layer coating film can be properly suppressed without hurting the color forming or good appearance of the coating film.

The average light transmissivity of the near ultraviolet range or the low-wavelength-side visible range of the upper-layer coating film is controllable by adjusting the pigment concentration or the thickness of the upper-layer coating film. Herein, the increase of the pigment concentration reduces the effect of shining materials, such as aluminum flakes or mica, so the concentration of the shining material may be preferably increased to maintain the proper effect of that. Further, the kind of materials to absorb the ultraviolet rays or their concentration may be also adjusted in addition to the adjusting of the pigment concentration. For example, in case the upper-layer coating film is formed by the color base coating film and the clear coating film, it is preferable that compared to the case of forming the second coating film, the pigment concentration of the base coating film be increased, and further the concentration of the ultraviolet-rays absorbing material of the clear coating film be increased.

Herein, it is preferable, in order to suppress the light deterioration of the lower-layer coating film more properly, that the upper-layer coating film have the average light transmissivity of the near ultraviolet range which is less than 0.15% and the average light transmissivity of the low-wavelength-side visible range which is 2.0% or less, or the average light transmissivity of the near ultraviolet range which is 0.15% or more and the average light transmissivity of the low-wavelength-side visible range which is 1.5% or less.

Another aspect of the present invention is a multi-layer coating film structure, comprising a lower-layer coating film, and an upper-layer coating film provided directly on the lower-layer coating film, wherein in case the upper-layer coating film has the average light transmissivity of the near ultraviolet range is A % and the average light transmissivity of the low-wavelength-side visible range is B %, the following formula (1) is satisfied.

45×A+10×B<100 (1)

The upper-layer coating film which is formed so as to satisfy the above-described formula is superior in suppressing the light deterioration of the lower-layer coating film, without hurting the color forming or good appearance of the coating film.

It is preferable, in order to suppress the light deterioration of the lower-layer coating film more properly, that in case the upper-layer coating film has the average light transmissivity of the near ultraviolet range is A % and the average light transmissivity of the low-wavelength-side visible range is B %, the following formula be satisfied,

135×A+30×B<100 (2)

According to a preferred embodiment of the present invention, the lower-layer coating film is an electrocoating film, and the upper-layer coating film includes a color base coating film.

Further, according to another preferred embodiment of the present invention, the electrocoating film is formed at an outer panel of a vehicle body with an epoxy-based cation electrocoating paint. That is, by setting the average light transmissivity of the near ultraviolet range and the low-wavelength-side visible range as described above, it can be properly suppressed over a long period of time that the conjugation of the aromatic ring of the epoxy resin of the electrocoating film gets broken so that the upper-layer coating film peels off from the electrocoating film (separation of layers).

Other features, aspects, and advantages of the present invention will become apparent from the following description which refers to the accompanying drawings.

### BRIEF DESCRIPTION OF THE DRAWINGS

FIG. 1 is a graph schematically showing the light transmissivity of an ultraviolet range and a visible range of a conventional upper-layer coating film.

FIG. 2 is a sectional view showing a multi-layer coating film structure according to an embodiment of the present invention.

FIG. 3 is a graph schematically showing the light transmissivity of the ultraviolet range and the visible range of multi-layer coating films (for four kinds of representative color) according to one embodiment of the present invention, separation of layers of which is expected to occur after an over-10-year use as an outer panel of a vehicle body.

FIG. 4 is a graph schematically showing the average light transmissivity of the ultraviolet range and the visible range of multi-layer coating films (for seventeen kinds of color) according to the embodiment of the present invention, separation of layers of which is expected to occur after the over-10-year use as the outer panel of the vehicle body.

FIG. 5 is a graph schematically showing the light transmissivity of the ultraviolet range and the visible range of multi-layer coating films (for the four kinds of representative color) according to another embodiment of the present invention, separation of layers of which is expected to occur after an over-30-year use as the outer panel of the vehicle body.

FIG. 6 is a graph schematically showing the average light transmissivity of the ultraviolet range and the visible range of multi-layer coating films (for the seventeen kinds of color) according to the embodiment of the present invention, separation of layers of which is expected to occur after the over-30-year use as the outer panel of the vehicle body.

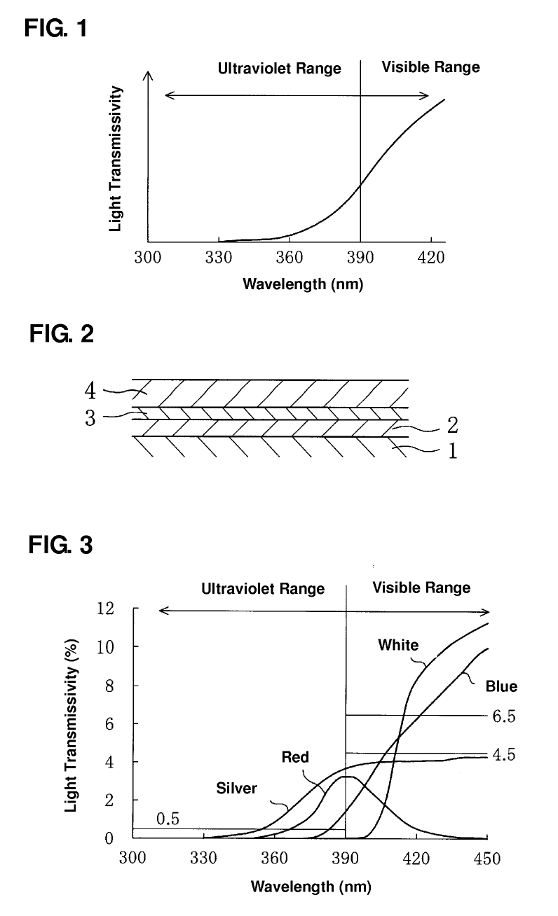

### DETAILED DESCRIPTION OF THE INVENTION

Hereinafter, preferred embodiments of the present invention will be described referring to the accompanying drawings. Herein, these preferred embodiments are merely examples of the present invention, and the present invention should not be limited to these embodiments in its application.

FIG. 2 is a sectional view showing a multi-layer coating film structure according to an embodiment of the present invention. In this figure, reference numeral 1 denotes a steel-made material to be coated (an outer panel of a vehicle body, for example). An electrocoating film 2 is formed on the surface of the material 1 as a lower-layer coating film. A base coating film 3 is directly formed on the electrocoating film 2 without forming any second coating film. Further, a clear coating film 4 is formed on the base coating film 3. The base coating film 3 and the clear coating film 4 constitute an upper-layer coating film of the present invention.

[Electrocoating Film 2]

The electrocoating film 2 can be formed on the material to be coated 1 through the processes of putting the material 1 into a cation electrocoating paint of an electrocoating bath and then applying a direct current between the material 1 as a plus terminal and a pole plate as a minus terminal. The cation electrocoating paint contains a cation epoxy resin, a pigment and some hardening agent and additive.

The cation epoxy resin includes an epoxy resin which is denaturalized by amines. Herein, an epoxy resin which is denaturalized by a resin, such as polyester polyol, polyether polyol, or alkylphenol, or an epoxy resin which has an extended chain length may be used.

An acid chloride, a sulfide, or an acid mixture of a primary amine, a secondary amine or a thirdly amine are used as a chemical compound which can introduce a cation radical. Such a chemical compound may include, for example, the secondary amine in which the primary amine, such as a ketimine of a butylamine, octylamine, diethylamine, dibutylamine, methylamine, monoethanolamine, diethanolamine, N-methylethanolamine, triethylamine hydrochloride, N,N-dimethyletanolamine acetate, dietyldisulfide acetic acid mixture, and aminoettylethanolamine, or a diketimine of a diethlenetriamine, is blocked.

A blockpolyisocyanate which is made by blocking a polyisocyanate with a blocking material may be used as the hardening agent. Herein, the polyisocyanate may be any one of compounds of the aliphatic group, alicylic, aromatic-aliphatic groups and the like.

An example of the aromatic-group isocyanate of the polyisocyanate is a tolylene diisocyanate (TDI), diphenylmethane diisocyanate (MDI), or the like. An example of the aliphatic-group isocyanate is a hexamethylene diisocyanate (HDI), 2,2,4-trimethylhexane diisocyanate, or the like. An example of the alicylic isocyanate is a 1,4-cyclohexane diisocyanate (CDI), isophorone diisocyanate (IPDI), 4,4′-dicyclohexylmethane diisocyanate (water-added MDI), 1,3-diisocyanatemethylcyclohexane (water-added XDI), water-added TDI, norbornane diisocyanate, or the like. An example of the aromatic-aliphatic-group isocyanate is a xylylene diisocyanate (XDI), tetramethylxylylene diisocyanate (TMXDI), or the like. Further, any denaturalized compound of the above-described isocyanate, such as a urethane compound, burette, or isocyanurate denaturalized compound, may be one of such examples. These may be used independently or combined.

An example of the blocking material is a lactam-based one such as ε-caprolactam, or an oxim-based one such as formaldoxime.

The amount of the hardening agent is generally within a range of 80/20 through 50/50 in expression of the weight ratio of its solid part relative to the hardening agent of the cation epoxy resin. The amount of the cation epoxy resin and the hardening agent is generally within a range of 30-80w % of the entire solid part of the electrocoating paint composition.

The electrocoating paint generally contains a pigment as a coloring material. An example of a coloring pigment is titanic oxide, carbon black, or iron oxide. An example of a constitution pigment is kaolin, talc, aluminum silicate, calcium carbonate, mica, or clay. An example of a rustproof pigment is phosphate of zinc, phosphate of iron, phosphate of aluminum, phosphate of calcium, zinc oxide, aluminum tripolyphosphate, zinc molybdate, aluminum molybdate, calcium molybdate, or the like. The amount of the pigment is preferably within a range of 10-30w % of the entire solid part of the electrocoating paint composition.

[Base Coating Film 3]

The base coating film 3 is formed by applying a water-soluble base paint or an oil (oleaginous) base paint. An acrylic resin, polyester resin, polyurethane resin, venial resin or the like may be used as a water-soluble resin of the water-soluble base paint.

The acrylic resin is made from acrylic emulsion, water-soluble acrylic resin, and the like. The acrylic emulsion is made by using a polymerized unsaturated monomer through an emulsion polymerization method, suspension polymerization method, dispersion polymerization method, or the like. An example of the polymerized unsaturated monomer is a polymerized unsaturated monomer containing a hydroxyl radical, a polymerized unsaturated monomer containing a carboxyl radical, aminoalkyl acrylate, aminoalkyl methacrylate, acryl amid, methacryl amid or its derivative, sulfoalkyl acrylate, polyvinyl compound, ultraviolet-rays absorbing or stable polymerized unsaturated monomer, or the like.

An example of the water-soluble acrylic resin is a polymerized unsaturated monomer containing a carboxyl radical, or a non-ionic polymerized unsaturated monomer containing a polyoxyalkylene chain. An example of the polymerized unsaturated monomer containing a carboxyl radical is the above-described polymerized unsaturated monomer of acrylic emulsion. An example of the non-ionic polymerized unsaturated monomer containing a polyoxyalkylene chain is a polyethylene glycol acrylate, polyethylene glycol methacrylate, polypropylene glycol acrylate, polypropylene glycol methacrylate, or the like.

The polyester resin may have the water-soluble or water-dispersion function through a neutralization of the carboxyl radical with a base. An example of the polyester resin containing the carboxyl radical is a resin which is made through an esterification reaction of a polybasic acid and a polyvalent alcohol under conditions of an excessive carboxyl radical compared to a hydroxyl radical, or a resin which is made by having acid anhydride react on a polyester polyol which is made through a reaction of a polybasic acid and a polyvalent alcohol under conditions of an excessive hydroxyl radical compared to a carboxyl radical. An example of the base for neutralization is an inorganic base, amines, or the like.

The pigment as the coloring material is added to the water-soluble base paint, and an example of the pigment is the coloring pigment, constitution pigment, shining pigment, or the like. An example of the organic coloring pigment is an azochelate pigment, insoluble azo pigment, condensation azo pigment, diketopyrrolopyrrole pigment, benzimidazolone pigment, phtharocyanine pigment, indigo pigment, perinone pigment, perylene pigment, dioxane pigment, quinacridone pigment, isoindorynone pigment, metal-complex pigment or the like. An example of the inorganic coloring pigment is chrome yellow, yellow iron oxide, bengala, carbon black, titanium dioxide, or the like. Further, calcium carbonate, barium sulfate, clay, talc or the like may be applied as the constitution pigment.

The water-soluble base paint may contain an additive for paint at need, such as a bridging agent, flat pigment, hardening catalyst, viscosity increasing agent, organic solvent, basic neutralizing agent, ultraviolet-rays absorbing agent, light stabilizing agent, surface regulating agent, antioxidant, silane coupling agent.

The bridging agent is a chemical compound which can form a hardening coating film through its reaction to bridging functional radicals (groups), such as a hydroxyl radical, carboxyl radical, epoxy radical of the water-soluble resin. An example of the bridging agent is a melamine resin, polyisocyanate compound, block-polyisocyanate compound, compound containing an epoxy radical, compound containing a carboxyl radical, compound containing a carbodiimide radical, or the like.

The water-soluble base paint may be applied onto the electrocoating film 2 of the material to be coated 1 by any coating, such as an air-spray coating, airless-spray coating, rotational-atomization coating, curtain-coat coating. Herein, an electrostatic impression may be conducted. The coating may be applied so that the dry thickness of coating film can be 12-18 μm, and after the coating a preheating at the temperature of 40-100 degrees C. for 1-15 minutes may be applied to evaporate water in the coating film at need.

[Clear Coating Film 4]

Any combination of the acryl resin and/or polyester resin and the amino resin, the acryl resin and/or polyester resin having carboxylic acid-epoxy hardening agent, or the like may be applied as the resin forming the clear coating film.

For example, a two-package urethane clear paint contains the acryl resin containing a hydroxyl radical and the polyisocyanate compound. An example of the acryl resin containing a hydroxyl radical is the polymerized unsaturated monomer containing a hydroxyl radical, or any other polymerized unsaturated monomers. An example of the polymerized unsaturated monomer containing a hydroxyl radical is a monoester compound of the polyvalent alcohol and the acryl acid or methacrylic acid, its compound with a ε-caprolactone polymerized, or the like. An example of the other polymerized unsaturated monomers is an alkylester of the acryl acid or methacrylic acid, polymerized unsaturated monomer containing a hydroxyl radical, aminoalkyl acrylate, aminoalkyl methacrylate, acryl amid, methacryl amid or its derivative, monomer containing a quaternary ammonium base, polyvinyl compound, ultraviolet-rays absorbing or stable polymerized unsaturated monomer, or the like.

An example of the polyisocyanate compound is an aliphatic diisocyanate group, cyclic aliphatic diisocyanate group, aromatic diisocyanate group, organic polyisocyanate itself, cyclic polymerization of combined organic polyisocyanate, isocyanate-burette, or the like.

An example of the organic solvent is a hydrocarbon-based solvent, ester-based solvent, ketone-based solvent, alcohol-based solvent, ether-based solvent, aromatic petroleum-based solvent, or the like.

To the clear paint may be added, at need, a pigment, non-water-dispersion resin, polymer particle, hardening catalyst, ultraviolet-rays absorbing agent, light stabilizing agent, paint-surface regulating agent, antioxidant, flowage regulating agent, wax, or the like. An example of the hardening catalyst is an organic tin compound, triethylamine, diethanolamine, or the like. An example of the ultraviolet-rays absorbing agent is any ultraviolet-rays stable agent, such as a benzophenone-based, benzotriazole-based, cyanoacrylate-based, salicylate-based, anilide oxalate-based, hindered amine-based compound.

The clear paint can be applied onto the base coating film 3 by any coating, such as the airless-spray coating, air-spray coating, rotational-atomization coating. Herein, the electrostatic impression may be conducted. The coating may be applied so that the dry thickness of coating film can be 35-40 μm, and after the coating a heating at the temperature of 140 degrees C. for 20 minutes may be applied.

### EMBODIMENTS

Coating for producing four kinds of multi-layer coating film structure with different colors of base-coating film was conducted. The same electrocoating and clear coating was used. Hereinafter, the conducted coating method will be described.

The cation electrocoating paint (“Power Top PN-1020” from NIPPON PAINT CO., LTD) was applied onto a cold rolled steel (material to be coated 1) which had been treated with phosphate of zinc and has the thickness of 0.8 mm and the size of 70 mm×150 mm so that the thickness of its dried coating film can be 20 μm. Then, it was heated at the temperature of 150 degrees C. for 30 minutes to form the electrocoating film 2.

The water-soluble base paint containing the polyurethane resin, acryl resin, melamine resin and pigment (“Aquarex AR-2000” from NIPPON PAINT CO., LTD) was applied onto the electrocoating film 2 so that the thickness of its dried coating film can be 15 μm. Then, it was heated at the temperature of 80 degrees C. for 5 minutes to evaporate the water in the base paint, and subsequently cooled down to the room temperature. Then, the two-package urethane paint (“PUO-3100”), which contains a main agent of the acryl resin containing a hydroxyl radical and a hardening agent containing the polyisocyanate compound, was applied so that the thickness of its dried coating film can be 35 nm. Then, it was heated at the temperature of 140 degrees C. for 20 minutes. Thus, the base paint 3 and the clear paint 4 were formed on the above-described electrocoating film 2.

The color kinds of the base coating film were four, i.e., white, blue, silver, and red. The main pigment kinds of the above-described water-soluble base paint were such that titanic oxide was for the white color, phthalocyanine-based blue pigment was for the blue color, aluminum flake was for the silver color, and quinacridone-based red pigment and diketopyrrolopyrrole-based pigment were for the red color.

The pigment concentration or the thickness of the respective color paints were adjusted so that the upper-layer coating film (the base paint 3 and the clear paint 4) had the average light transmissivity of the near ultraviolet range which was less than 0.5% and the average light transmissivity of the low-wavelength-side visible range which was 6.5% or less, or the average light transmissivity of the near ultraviolet range which was 0.5% or more and the average light transmissivity of the low-wavelength-side visible range which was 4.5% or less, as shown in a table 1.

TABLE 1

| | Concentration of Pigments | Thickness (μm) | |
|---|---|---|---|
| Paint Colors | (mass %) | Base | Clear |
| White (white 1) | 60 | 15 | 35 |
| Blue (blue mica 1) | 20 | 15 | 35 |
| Silver (silver metallic 3) | 15 | 15 | 35 |
| Red (red) | 30 | 15 | 35 |

Results of measurement of the respective average light transmissivity of the near ultraviolet range and the low-wavelength-side visible range of the upper-layer coating film (the base paint 3+the clear paint 4) according these paint colors are shown in FIG. 3. The average light transmissivity of the white were 0.02% (less than 0.5%) for the near ultraviolet range and 6.44% (6.5% or less) for the low-wavelength-side visible range. The average light transmissivity of the blue were 0.09% (less than 0.5%) for the near ultraviolet range and 6.18% (6.5% or less) for the low-wavelength-side visible range. The average light transmissivity of the silver were 0.96% (more than 0.5%) for the near ultraviolet range and 4.06% (4.5% or less) for the low-wavelength-side visible range. The average light transmissivity of the red were 1.37% (more than 0.5%) for the near ultraviolet range and 3.10% (4.5% or less) for the low-wavelength-side visible range.

The above-described average light transmissivity of the near ultraviolet range and the low-wavelength-side visible range of the upper-layer coating film according the respective paint colors are equivalent to an expected level in that a separation of layers of the upper-layer coating film and the electrocoating film 2 may occur after an over-10-year use as an outer panel of a vehicle body.

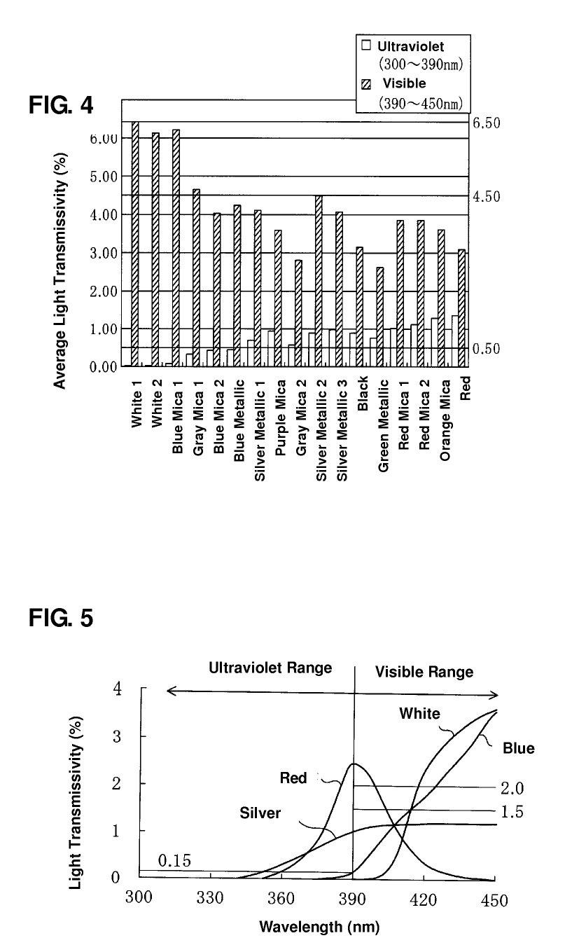

In addition to the above-described four colors, the similar coatings were conducted for other thirteen colors as well. A table 2 and FIG. 4 show results of the measurements of the respective average light transmissivity of the near ultraviolet range and the low-wavelength-side visible range of the upper-layer coating film for all of the seventeen paint colors including the above-described four colors.

TABLE 2

| | Average Light Transmissivity | | |
|---|---|---|---|
| Paint Colors | 300-390 nm | 390-450 nm | 300-450 nm |
| White 1 | 0.02 | 6.44 | 2.61 |
| White 2 | 0.03 | 6.10 | 2.48 |
| Blue Mica 1 | 0.09 | 6.18 | 2.54 |
| Gray Mica 1 | 0.32 | 4.63 | 2.05 |
| Blue Mica 2 | 0.43 | 4.02 | 1.87 |
| Blue Metallic | 0.45 | 4.23 | 1.96 |
| Silver Metallic 1 | 0.70 | 4.10 | 2.06 |
| Purple Mica | 0.95 | 3.57 | 2.00 |
| Gray Mica 2 | 0.59 | 2.80 | 1.47 |
| Silver Metallic 2 | 0.88 | 4.52 | 2.33 |
| Silver Metallic 3 | 0.96 | 4.06 | 2.19 |
| Black | 0.89 | 3.14 | 1.78 |
| Green Metallic | 0.76 | 2.62 | 1.50 |
| Red Mica 1 | 1.02 | 3.85 | 2.14 |
| Red Mica 2 | 1.12 | 3.82 | 2.18 |
| Orange Mica | 1.30 | 3.61 | 2.20 |
| Red | 1.37 | 3.10 | 2.03 |

It can be understood that in case the average light transmissivity of the near ultraviolet range of the upper-layer coating film is less than 0.5%, the use life (endurance term) may be 10 years if the average light transmissivity of the low-wavelength-side visible range is 6.5% or more. Meanwhile, it can be understood that even in case the average light transmissivity of the near ultraviolet range of the upper-layer coating film is 0.5% or more (0.5% or more and 1.5% or less), the use life (endurance term) may be 10 years if the average light transmissivity of the low-wavelength-side visible range is 4.5% or more. It is apparent from the table 2 that the average light transmissivity of the wavelength range of 300 through 450 nm is 3% or less, specifically, 2.61% or less. It is preferable but not limited to that the average light transmissivity of the wavelength range of 300 through 450 nm be 0.15% or more.

Next, another coating using the similar coating method described above was conducted by adjusting the pigment concentration of the base paint and the thickness of the base coating film, additionally by adjusting the ultraviolet-rays absorbing agent of the clear paint and the thickness of the clear coating film at need, so that the average light transmissivity can be equivalent to an expected level in that the above-described separation of layers may occur after an over-30-year use as the outer panel of the vehicle body (the average light transmissivity of the near ultraviolet range can be less than 0.15% and the average light transmissivity of the low-wavelength-side visible range can be 2.0% or less, or the average light transmissivity of the near ultraviolet range can be 0.15% or more and the average light transmissivity of the low-wavelength-side visible range can be 1.5% or less).

FIG. 5 shows results of the measurements of the average light transmissivity of the near ultraviolet range and the low-wavelength-side visible range of the upper-layer coating film for the representative colors (white, blue, silver and red). The average light transmissivity of the white were 0.00% (less than 0.15%) for the near ultraviolet range and 1.94% (2.0% or less) for the low-wavelength-side visible range. The average light transmissivity of the blue were 0.01% (less than 0.15%) for the near ultraviolet range and 1.89% (2.0% or less) for the low-wavelength-side visible range. The average light transmissivity of the silver were 0.27% (more than 0.15%) for the near ultraviolet range and 1.18% (1.5% or less) for the low-wavelength-side visible range. The average light transmissivity of the red were 0.40% (more than 0.15%) for the near ultraviolet range and 0.80% (1.5% or less) for the low-wavelength-side visible range.

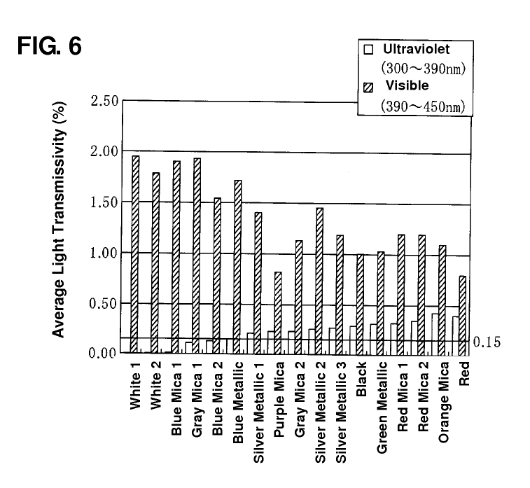

A table 3 and FIG. 6 show results of the measurements of the respective average light transmissivity of the near ultraviolet range and the low-wavelength-side visible range of the upper-layer coating film for all of the seventeen paint colors including the above-described four colors.

TABLE 3

| | Average Light Transmissivity | | |
|---|---|---|---|
| Paint Colors | 300-390 nm | 390-450 nm | 300-450 nm |
| White 1 | 0.00 | 1.94 | 0.78 |
| White 2 | 0.00 | 1.78 | 0.72 |
| Blue Mica 1 | 0.01 | 1.89 | 0.77 |
| Gray Mica 1 | 0.10 | 1.92 | 0.83 |
| Blue Mica 2 | 0.12 | 1.53 | 0.69 |
| Blue Metallic | 0.14 | 1.71 | 0.77 |
| Silver Metallic 1 | 0.20 | 1.40 | 0.68 |
| Purple Mica | 0.22 | 0.82 | 0.46 |
| Gray Mica 2 | 0.22 | 1.13 | 0.59 |
| Silver Metallic 2 | 0.25 | 1.45 | 0.73 |
| Silver Metallic 3 | 0.27 | 1.18 | 0.63 |
| Black | 0.29 | 0.99 | 0.57 |
| Green Metallic | 0.31 | 1.03 | 0.59 |
| Red Mica 1 | 0.32 | 1.19 | 0.66 |
| Red Mica 2 | 0.34 | 1.19 | 0.67 |
| Orange Mica | 0.42 | 1.10 | 0.68 |
| Red | 0.40 | 0.80 | 0.55 |

It can be understood that in case the average light transmissivity of the near ultraviolet range of the upper-layer coating film is less than 0.15%, the use life (endurance term) may be 30 years if the average light transmissivity of the low-wavelength-side visible range is 0.15% or more. Meanwhile, it can be understood that even in case the average light transmissivity of the near ultraviolet range of the upper-layer coating film is 0.15% or more (0.15% or more and 0.45% or less), the use life (endurance term) may be 30 years if the average light transmissivity of the low-wavelength-side visible range is 1.5% or less. It is apparent from the table 3 that the average light transmissivity of the wavelength range of 300 through 450 nm is 0.9% or less, specifically, 0.83% or less. It is preferable but not limited to that the average light transmissivity of the wavelength range of 300 through 450 nm be 0.15% or more.

[Relationship Between Light Transmissivity of Near Ultraviolet Range and Light Transmissivity of Low-Wavelength-Side Visible Range]

While the average light transmissivity of the low-wavelength-side visible range is greater than the average light transmissivity of the near ultraviolet range, the influence of the light of the low-wavelength-side visible range on the deterioration of the lower-layer coating film (electrocoating film) is relatively small compared to the light of the near ultraviolet range as described above. The inventors of the present invention investigated the average light transmissivity of the low-wavelength-side visible range which can provide a specified use life (endurance term) in case the light transmissivity of the near ultraviolet range is zero, and the average light transmissivity of the near ultraviolet range which can provide the specified use life (endurance term) in case the light transmissivity of the low-wavelength-side visible range is zero. Consequently, it was found that the average light transmissivity of the low-wavelength-side visible range was about 4.5 times as great as the average light transmissivity of the near ultraviolet range.

Accordingly, it was found that in case the upper-layer coating film has the average light transmissivity of the near ultraviolet range is A % and the average light transmissivity of the low-wavelength-side visible range is B %, the following formula (1) needs to be satisfied in order to provide the over-10-year use life (endurance term).

45×A+10×B<100 (1)

Likewise, it was found out that the following formula (2) needs to be satisfied in order to provide the over-30-year use life (endurance term).

135×A+30×B<100 (2)

All the average light transmissivity of the near ultraviolet range and the low-wavelength-side visible range of the respective colors in the table 2 satisfy the above-descried formula (1). All the average light transmissivity of the near ultraviolet range and the low-wavelength-side visible range of the respective colors in the table 3 satisfy the above-descried formula (2).

Thus, the multi-layer coating film structure which can improve the deterioration resistance against lights properly can be provided by adjusting the pigment concentration of the base paint and the thickness of the base coating film, additionally by adjusting the ultraviolet-rays absorbing agent of the clear paint and the thickness of the clear coating film at need, so as to satisfy the above-described formulas (1) or (2).

Further, in case the average light transmissivity of the near ultraviolet range is fixed, the above-described use life prolongs as the average light transmissivity of the low-wavelength-side visible range becomes smaller. To the contrary, in case the average light transmissivity of the low-wavelength-side visible range is fixed, the use life prolongs as the average light transmissivity of the near ultraviolet range becomes smaller. According to the investigation, for example, in case the average light transmissivity of the near ultraviolet range is 0.15%, the use life may be 10 years if the average light transmissivity of the low-wavelength-side visible range is 6.5%, and the use life may be 30 years if the average light transmissivity of the low-wavelength-side visible range is 1.5%. Meanwhile, in case the average light transmissivity of the near ultraviolet range is 0.5%, the use life may be 10 years if the average light transmissivity of the low-wavelength-side visible range is 4.2%, and the use life may be 30 years if the average light transmissivity of the low-wavelength-side visible range is about 0%.

While the base coating film was formed by the water-soluble base paint in the above-described embodiment, it may be formed by an oil-soluble base paint, such as a melamine hardening-type of oil-soluble paint containing the polyurethane resin, acryl resin, melamine resin and pigment (“OTO H-700” from NIPPON PAINT CO., LTD). In this case, any coating, such as the airless-spray coating, air-spray coating, rotational-atomization coating (herein, the electrostatic impression may be conducted), may be applied so as to form a specified dried coating thickness, and then it may be cooled down to the room temperature.

Further, the clear base coating film may be formed with a carboxylic acid/epoxy hardening-type paint (“MACO-1600” from NIPPON PAINT CO., LTD) by any coating, such as the airless-spray coating, air-spray coating, rotational-atomization coating (herein, an electrostatic impression may be conducted).

Herein, the thickness of the base coating film and the clear coating film described in the above-described embodiments are just examples, the present invention should not be limited to such thickness. Instead of increasing the pigment concentration of the base coating film or in addition to this, the thickness of the upper-layer canting film, that is, the thickness of the base coating film or the clear coating film may be increased to lower the light transmissivity of the near ultraviolet range and the low-wavelength-side visible range.

What is claimed is:

1. A multi-layer coating film structure, comprising:
a lower-layer coating film; and
an upper-layer coating film provided directly on the lower-layer coating film,
wherein said upper-layer coating film has the average light transmissivity of a wavelength range of 300 through 390 nm which is less than 0.5% and the average light transmissivity of a wavelength range of 390 through 450 nm which is 6.5% or less, or the average light transmissivity of the wavelength range of 300 through 390 nm which is 0.5% or more and the average light transmissivity of the wavelength range of 390 through 450 nm which is 4.5% or less.

2. A multi-layer coating film structure, comprising:
a lower-layer coating film; and
an upper-layer coating film provided directly on the lower-layer coating film,
wherein said upper-layer coating film has the average light transmissivity of a wavelength range of 300 through 390 nm which is less than 0.15% and the average light transmissivity of a wavelength range of 390 through 450 nm which is 2.0% or less, or the average light transmissivity of the wavelength range of 300 through 390 nm which is 0.15% or more and the average light transmissivity of the wavelength range of 390 through 450 nm which is 1.5% or less.

3. A multi-layer coating film structure, comprising:
a lower-layer coating film; and
an upper-layer coating film provided directly on the lower-layer coating film,
wherein in case said upper-layer coating film has the average light transmissivity of a wavelength range of 300 through 390 nm is A % and the average light transmissivity of a wavelength range of 390 through 450 nm is B %, the following formula is satisfied,
45×A+10×B<100.

4. A multi-layer coating film structure, comprising:
a lower-layer coating film; and
an upper-layer coating film provided directly on the lower-layer coating film,
wherein in case said upper-layer coating film has the average light transmissivity of a wavelength range of 300 through 390 nm is A % and the average light transmissivity of a wavelength range of 390 through 450 nm is B %, the following formula is satisfied,
135×A+30×B<100.

5. The multi-layer coating film structure of claim 1, wherein said lower-layer coating film is an electrocoating film, and said upper-layer coating film includes a color base coating film.

6. The multi-layer coating film structure of claim 2, wherein said lower-layer coating film is an electrocoating film, and said upper-layer coating film includes a color base coating film.

7. The multi-layer coating film structure of claim 3, wherein said lower-layer coating film is an electrocoating film, and said upper-layer coating film includes a color base coating film.

8. The multi-layer coating film structure of claim 4, wherein said lower-layer coating film is an electrocoating film, and said upper-layer coating film includes a color base coating film.

9. The multi-layer coating film structure of claim 5, wherein said electrocoating film is formed at an outer panel of a vehicle body with an epoxy-based cation electrocoating paint.

10. The multi-layer coating film structure of claim 6, wherein said electrocoating film is formed at an outer panel of a vehicle body with an epoxy-based cation electrocoating paint.

11. The multi-layer coating film structure of claim 7, wherein said electrocoating film is formed at an outer panel of a vehicle body with an epoxy-based cation electrocoating paint.

12. The multi-layer coating film structure of claim 8, wherein said electrocoating film is formed at an outer panel of a vehicle body with an epoxy-based cation electrocoating paint.
